(19) United States
(12) Patent Application Publication
(10) Pub. No.: US 2006/0190631 A1
(43) Pub. Date: Aug. 24, 2006

(54) Method for configuring an input device and input device used therein

(75) Inventor: Chin-Chou Lee, Hsinchu Hsien (TW)

Correspondence Address: PILLSBURY WINTHROP SHAW PITTMAN, LLP, P.O. BOX 10500, MCLEAN, VA, 22102, US

(73) Assignee: PIXART IMAGING INC., Hsinchu Hsien (TW)

(21) Appl. No.: 11/250,342

(22) Filed: Oct. 17, 2005

(30) Foreign Application Priority Data
Feb. 23, 2005 (TW) 94105391

(51) Int. Cl. G06F 3/00

(52) U.S. Cl. 710/8

(57) ABSTRACT

A method for configuring an input device that includes a housing, a plurality of user operable members installed on the housing, a calculating unit installed in the housing and coupled to the user operable members, and a memory installed in the housing and coupled to the calculating unit, includes the steps of storing a lookup table that contains user input conditions and functions corresponding to input device control parameters into the memory, enabling the calculating unit to detect the operation of the user operable members, enabling the calculating unit to match the detected operation of the user operable members to the lookup table stored in the memory, and enabling the calculating unit to configure the input device using the input device control parameters. An input device that performs the method is also disclosed.

### CROSS-REFERENCE TO RELATED APPLICATION

This application claims priority of Taiwanese application no. 094105391, filed on Feb. 23, 2005.

### BACKGROUND OF THE INVENTION

1. Field of the Invention

This invention relates to a method for configuring an input device and to an input device that can be configured using the method.

2. Description of the Related Art

Input devices, such as an optical mouse, are well known in the art. Typically, the input device includes a pair of finger depressable buttons for item selection, and a scroller, such as a partially exposed wheel, for window size and scroll control. The input device generates a control signal upon operation of a corresponding one of the finger depressable buttons and the scroller.

The aforesaid input device is disadvantageous in that repeated control signals cannot be generated without user operation of the finger depressable buttons. Moreover, the input device is configurable only for either 400 or 800 cpi resolution. Furthermore, the input device may only be configured through software, i.e., through an operating system, installed in a computer, such as Windows XP.

### SUMMARY OF THE INVENTION

Therefore, the object of the present invention is to provide a method for configuring an input device by operating the input device itself.

Another object of the present invention is to provide an input device that is configurable by simply operating the same.

According to one aspect of the present invention, a method for configuring an input device that includes a housing, a plurality of user operable members installed on the housing, a calculating unit installed in the housing and coupled to the user operable members, and a memory installed in the housing and coupled to the calculating unit, comprises the steps of:

A) storing a lookup table that contains a plurality of sets of input device control parameters into the memory;

B) detecting the operation of the user operable members;

C) matching the detected operation of the user operable members to the lookup table stored in the memory; and

D) enabling the calculating unit to configure the input device using the set of input device control parameter associated with the matched user input conditions.

According to another aspect of the present invention, an input device comprises a housing, a plurality of user operable members which are installed on the housing, a calculating unit which is installed in the housing and which is coupled to the user operable members, and a memory which is installed in the housing, which is coupled to the calculating unit, and which stores a lookup table that contains user input conditions and functions corresponding to input device control parameters. The calculating unit is operable so as to detect the operation of the user operable members, so as to match the detected operation of the user operable members to the lookup table stored in the memory, and so as to configure the input device using the input device control parameter associated with the matched user input conditions.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of the preferred embodiment of an input device according to the present invention;

FIG. 2 is a schematic block diagram of the preferred embodiment;

FIG. 3 is a flowchart to illustrate the preferred embodiment of a method for configuring the input device according to the present invention; and

FIGS. 4 and 5 are time charts to illustrate operation of the preferred embodiment.

### DETAILED DESCRIPTION OF THE PREFERRED EMBODIMENT

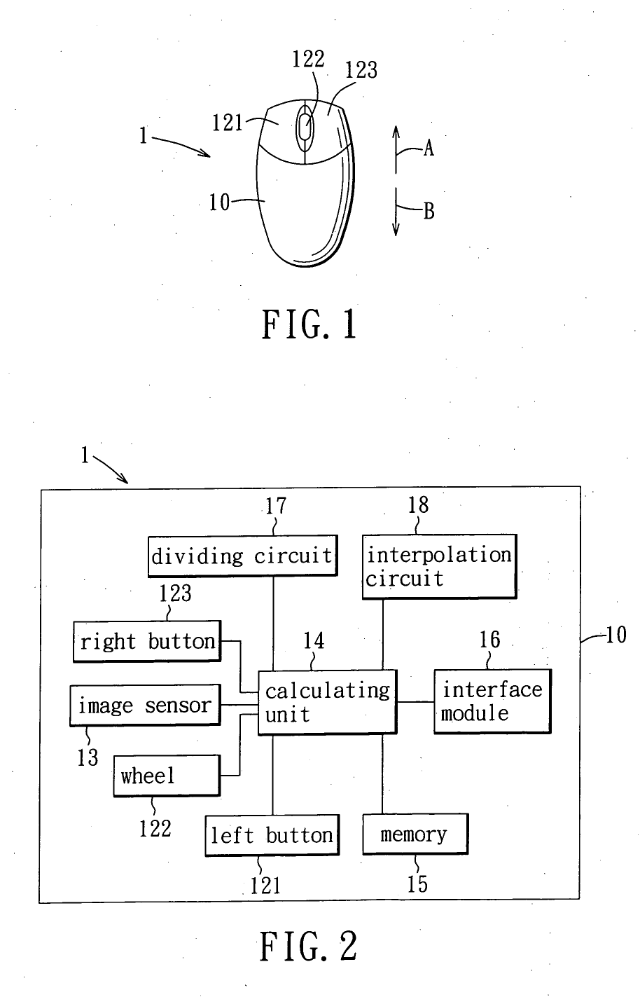

Referring to FIGS. 1 and 2, the preferred embodiment of an input device 1 according to this invention is shown to include a housing 10, a plurality of user operable members, a calculating unit 14, and a memory 15.

In this embodiment, the input device 1 is an optical mouse, and includes three of the user operable members, two of which are finger depressable buttons 121, 123 (herein referred to as left and right buttons) and one of which is a wheel 122 for the purpose of scrolling. Each of the left and right buttons 121, 123, and the wheel 122 is installed operably on the housing 10 in a known manner.

The calculating unit 14 is installed in the housing 10, is coupled to the user operable members, and is operable so as to generate a control signal upon operation of one of the user operable members in a known manner. In this embodiment, the calculating unit 14 may be a micro control unit (MCU), an application-specific integrated circuit (ASIC), or any of its variants as known to one skilled in the field.

The memory 15 is installed in the housing 10, is coupled to the calculating unit 14, and stores a lookup table, as illustrated in Table 1, that contains user input conditions and functions corresponding to input device control parameters.

TABLE 1

| | Functions corresponding to |
|---|---|
| | input device control |
| User input conditions | parameters |
| 1) depress the right button | Automatic mode |
| for at least one second, | |
| click the left button, and | |
| release the right button | |
| 2) depress the left button | Normal mode |
| for at least one second, | |
| click the right button, and | |
| release the left button | |
| 3) depress the right button, | Increase/decrease report |
| and rotate the wheel | rate |
| 4) depress the left and right | Increase/decrease |
| buttons for at least one | resolution |
| second, and rotate the wheel | |

In this embodiment, the calculating unit 14 is further operable so as to detect the operation of the user operable members, so as to match the detected operation of the user operable members to the lookup table stored in the memory 15, and so as to configure the input device 1 using the input device control parameter associated with the matched user input conditions, in a manner that will be described hereinafter.

The input device 1 further includes an image sensor 13 and an interface module 16, each of which is installed in the housing 10 and is coupled to the calculating unit 14. The image sensor 13 detects movement of the input device 1 in a known manner. The interface module 16 is adapted to link the input device 1 to a computer (not shown) to permit the input device 1 to interact with the computer in a known manner.

In this embodiment, the input device 1 further includes a dividing circuit 17 and an interpolation circuit 18 to realize a plurality of different resolutions of the input device 1 available for selection by the calculating unit 14 in a manner that will be described hereinafter.

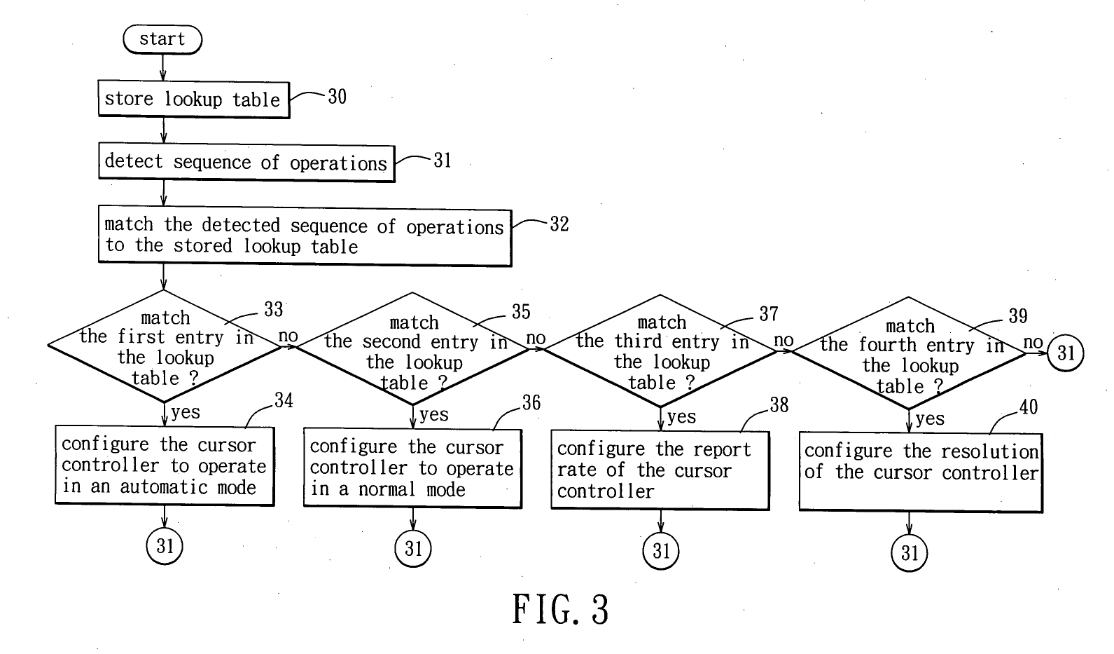

The preferred embodiment of a method for configuring the input device 1 according to this invention will now be described with further reference to FIG. 3.

In step 30, the lookup table, as illustrated in Table 1, which contains the user input conditions and the functions corresponding to input device control parameters, is stored into the memory 15.

In step 31, the calculating unit 14 detects the operation of the user operable members.

In step 32, the calculating unit 14 matches the detected operation of the user operable members to the lookup table stored in the memory 15.

In step 33, when the calculating unit 14 determines that the detected operation of the user operable members matches the first entry in the lookup table, the flow proceeds to step 34. Otherwise, the flow proceeds to step 35.

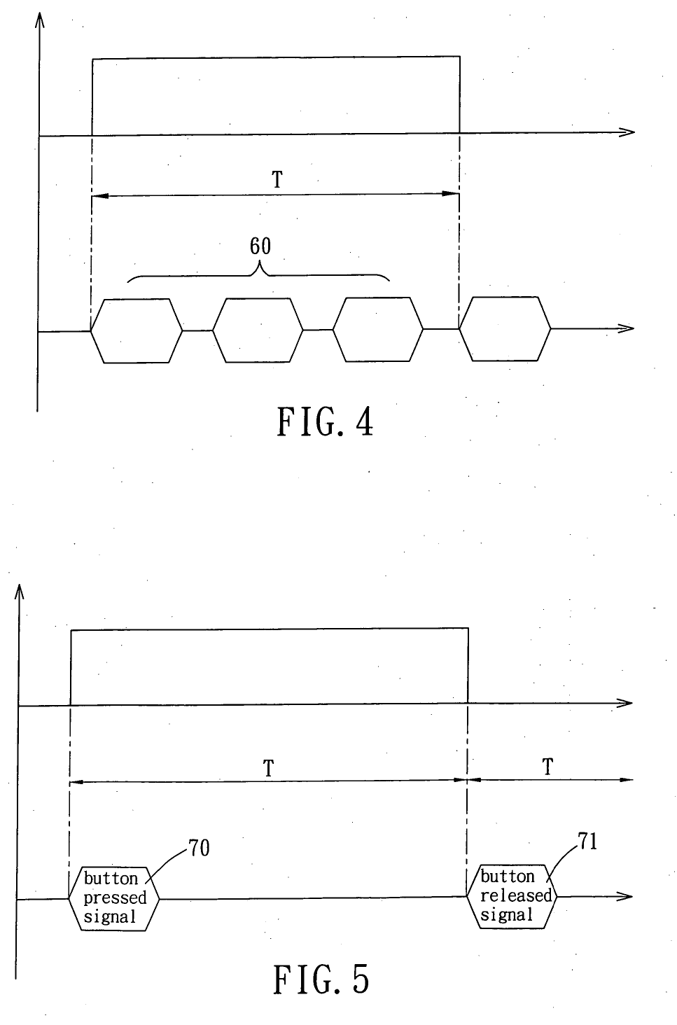

In step 34, the calculating unit 14 configures the input device 1 to operate in an automatic mode. In this mode, the input device 1 generates repeated control signals automatically. For example, as illustrated in FIG. 4, when the left button 121 is depressed within a period (T), the input device 1 generates repeated control signals 60, which emulate depression and released of the left button 121, during the period (T) Thereafter, the flow goes back to step 31.

In step 35, when the calculating unit 14 determines that the detected operation of the user operable members matches the second entry in the lookup table, the flow proceeds to step 36. Otherwise, the flow proceeds to step 37.

In step 36, the calculating unit 14 configures the input device 1 to operate in the normal mode. In this mode, the input device 1 generates control signals in a conventional manner, i.e., repeated control signals require repeated user operation of the user operable members. For example, as illustrated in FIG. 5, when the left button 121 is depressed within a period (T), the input device 1 generates the control signal 70, indicative of the left button 121 being depressed, during the period (T), and the control signal 71, indicative of the left button 121 being released. Thereafter, the flow goes back to step 31.

In step 37, when the calculating unit 14 determines that the detected operation of the user operable members matches the third entry in the lookup table, the flow proceeds to step 38. Otherwise, the flow proceeds to step 39.

In step 38, the calculating unit 14 configures the report rate of the input device 1 when the latter is operated in the automatic mode. That is, when the right button 123 is depressed and when the wheel 122 is rotated in a first direction, as indicated by arrow (A) in FIG. 1, the calculating unit 14 increases the report rate of the input device 1 in accordance with the angular displacement of the wheel 122. On the other hand, when the right button 123 is depressed and when the wheel 122 is rotated in a second direction opposite to the first direction, as indicated by arrow (B) in FIG. 1, the calculating unit 14 decreases the report rate of the input device 1 in accordance with the angular displacement of the wheel 122. Thereafter, the flow goes back to step 31.

It is noted that, in this embodiment, the input device 1 may be configured with report rates of 10, 20, 30, 40, 60, 80, 100, and 200 reports per second. In an alternative embodiment, the input device 1 may be configured with report rates between 100 and 125 reports per second.

In step 39, when the calculating unit 14 determines that the detected operation of the user operable members matches the fourth entry in the lookup table, the flow proceeds to step 40. Otherwise, the flow goes back to step 31.

In step 40, the calculating unit 14 configures the resolution of the input device 1. That is, when the left and right buttons 121, 123 are simultaneously depressed and when the wheel 122 is rotated in the first direction (A), the calculating unit 14 increases the resolution of the input device 1 in accordance with the angular displacement of the wheel 122. On the other hand, when the left and right buttons 121, 123 are simultaneously depressed and when the wheel 122 is rotated in the second direction (B), the calculating unit 14 decreases the resolution of the input device 1 in accordance with the angular displacement of the wheel 122. Thereafter, the flow goes back to step 31.

In this embodiment, through the use of the dividing circuit 17 and the interpolation circuit 18, the following resolutions for the input device 1 are available for selection by the calculating unit 14: 2000, 1800, 1600, 1400, 1200, 1000, 800, 600, 400, and 200 cpi.

Since the resolution of the input device 1 is configured through hardware, i.e., through the dividing and interpolation circuits 17, 18, the resolution thus obtained is relatively accurate and reliable as compared to that configured through software.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for configuring an input device that includes a housing, a plurality of user operable members installed on the housing, a calculating unit installed in the housing and coupled to at least one of the user operable members, and a memory installed in the housing and coupled to the calculating unit, said method comprising the steps of:
A) storing a lookup table that contains a plurality of sets of input device control parameters into the memory;
B) detecting the operation of the user operable members;
C) matching the detected operation of the user operable members to the lookup table stored in the memory; and
D) enabling the calculating unit to configure the input device using the set of input device control parameters associated with the matched user input conditions.

2. The method as claimed in claim 1, wherein, in step D), the calculating unit configures the report rate of the input device.

3. The method as claimed in claim 1, wherein, in step D), the calculating unit configures the resolution of the input device.

4. An input device, comprising:
a housing;
a plurality of user operable members installed on said housing;
a calculating unit installed in said housing and coupled to said user operable members; and
a memory installed in said housing, coupled to said calculating unit, and storing a lookup table that contains user input conditions and functions corresponding to input device control parameters;
wherein, said calculating unit is operable so as to detect the operation of said user operable members, so as to match the detected operation of said user operable members to said lookup table stored in said memory, and so as to configure said input device using the input device control parameter associated with the matched user input conditions.

5. The input device as claimed in claim 4, wherein at least one of said user operable members is a finger depressable button,
the user input conditions contained in said lookup table including depression of said finger depressable button beyond a predetermined time interval.

6. The input device as claimed in claim 4, wherein one of said user operable members is a wheel that is installed operably on said housing,
the user input conditions contained in said lookup table including rotational directions and angular displacement of said wheel,
said calculating unit detecting the rotational direction and the angular displacement of said wheel when a specified one of said user operable members is operated in a predetermined manner.

7. The input device as claimed in claim 6, wherein said calculating unit is operable so as to configure the report rate of said input device according to the detected rotational direction and the detected angular displacement of the wheel.

8. The input device as claimed in claim 6, wherein said calculating unit is operable so as to configure the resolution of said input device according to the detected rotational direction and the detected angular displacement of the wheel.

9. The input device as claimed in claim 4, wherein said calculating unit is operable so as to configure the report rate of said input device.

10. The input device as claimed in claim 4, wherein said calculating unit is operable so as to configure the resolution of said input device.

11. The input device as claimed in claim 10, further comprising a dividing circuit and an interpolation circuit to realize a plurality of different resolutions of said input device available for selection by said calculating unit.

12. A method for configuring an input device including a housing, a plurality of user operable members installed on the housing, a calculating unit installed in the housing and coupled to at least one of the user operable members, and a memory installed in the housing and coupled to the calculating unit, the method comprising the steps of:
A) storing into the memory a lookup table which contains a plurality of sets of input device control parameters associated with predetermined user input conditions;
B) enabling the calculating unit to detect the operation of the user operable members;
C) selecting a set of input device control parameters in the lookup table based on the detected operation of the user operable members; and
D) configuring at least one of operation parameters of the input device by the selected set of input device control parameters.

13. The method of claim 12, wherein, in step D), one of the operation parameters of the input device is a report rate of the input device.

14. The method of claim 12, wherein, in step D), one of the operation parameters of the input device is a resolution of the input device.

15. The method of claim 12, at least one of the user operable members being a finger depressable button, wherein the user input conditions contained in the lookup table include depression time of the finger depressable button beyond a predetermined time interval.

16. The method of claim 12, at least one of the user operable members being a scroller installed operably on the housing, wherein the user input conditions contained in the lookup table include rotational directions and angular displacements of the scroller detected by the calculating unit.

17. The method of claim 16, wherein the calculating unit configures the report rate of the input device according to the detected rotational direction and the detected angular displacement of the scroller.

18. The method of claim 16, wherein the calculating unit configures the resolution of the input device according to the detected rotational direction and the detected angular displacement of the scroller.

19. An input device, comprising:
a housing;
a plurality of user operable members installed on the housing;
a calculating unit installed in the housing and coupled at least one of the user operable members; and
a memory installed in the housing, coupled to the calculating unit and storing a lookup table which contains a plurality of sets of input device control parameters associated with user input conditions;
wherein the calculating unit is operable so as to detect the operation of the user operable members, select a set of input device control parameters in the lookup table based on the detected operation of the user operable members, and configure at least one of operation parameters of the input device by the selected set of input device control parameters.

20. The input device of claim 19, at least one of the user operable members being a finger depressable button, wherein the user input conditions contained in the lookup table include depression time of the finger depressable button beyond a predetermined time interval.

21. The input device of claim 19, at least one of the user operable members being a scroller installed operable on the housing, wherein the user input conditions contained in the lookup table include rotational directions and angular displacements of the scroller, and the calculating unit detects the rotational direction and the angular displacement of the scroller when a specified one of the user operable members is operated in a predetermined manner.

22. The input device of claim 21, wherein the calculating unit is operable so as to configure the report rate of the input device according to the detected rotational direction and the detected angular displacement of the scroller.

23. The input device of claim 21, wherein said calculating unit is operable so as to configure the resolution of the input device according to the detected rotational direction and the detected angular displacement of the scroller.

24. The input device as claimed in claim 19, wherein the calculating unit is operable so as to configure the report rate of the input device.

25. The input device of claim 19, wherein the calculating unit is operable so as to configure the resolution of the input device.

26. The input device of claim 25, further comprising a dividing circuit and an interpolation circuit to realize a plurality of different resolutions of the input device available for selection by the calculating unit.
